(19) United States
(12) Patent Application Publication
(10) Pub. No.: US 2002/0166686 A1
(43) Pub. Date: Nov. 14, 2002

(54) Sheet for electronic parts and method of producing the same

(76) Inventors: Junichi Toyoda, Tokyo (JP); Katsumi Okayama, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/034,943

(22) Filed: Dec. 27, 2001

(30) Foreign Application Priority Data
Dec. 27, 2000 (JP) P2000-397346

(51) Int. Cl. H02G 3/08

(52) U.S. Cl. 174/52.1

(57) ABSTRACT

A sheet for electronic parts which includes an electromagnetic wave-absorbing heat-radiating layer containing a magnetic material powder, for example, a ferrite, Sendust or the like, a heat-conductive powder, for example, alumina, aluminum nitride or the like and a resin, and a shield layer which is an electrically conductive layer including a metallic foil, for example, copper foil, aluminum foil or the like, or including an electrically conductive powder of carbon or the like and a resin, laminated on the electromagnetic wave-absorbing heat-radiating layer, and a method of producing the same.

### BACKGROUND OF THE INVENTION

The present invention relates to a sheet for electronic parts which has an electromagnetic wave absorbing and shielding function and a heat radiation promoting function, and a method of producing the same.

The operating frequencies of various electronic apparatuses such as personal computers, cellular phones, etc. have become more and more higher. Attendant on this, the frequencies of unrequired radiation noises generated from the electronic apparatuses have also been raised from the MHz band to the GHz band. Accordingly, the conventional noise countermeasure parts have been becoming insufficient in noise-attenuating effects.

In addition, since reductions in size and weight of the electronic apparatuses have been under way rapidly, influences of the unrequired radiations on the parts inside a casing have also come to be a problem. For example, in the case of an electronic apparatus including a casing formed of an electrically conductive material such as metal, the unrequired radiations from the parts contained in the casing are reflected by the casing and may interfere with the operations of the parts.

Further, since the distance between the parts inside the casing has been becoming smaller, mutual interference of the unrequired radiations between the parts has come to be more conspicuous.

Although a variety of noise countermeasure parts have hitherto been developed, the reduction in the size of electronic apparatuses has come to make it difficult to secure installation space for the noise countermeasure parts. Therefore, there is a request for a noise countermeasure part which is high in performance and demands a smaller installation space.

On the other hand, attendant on the reductions in size and weight of electronic apparatuses, heat generation of the electronic apparatuses has become a serious problem, in addition to the above-mentioned problem of noise. The heat generation may cause malfunction of the electronic apparatuses or may shorten the useful life of the electronic apparatuses.

As a member for electronic parts which has both an electromagnetic wave shielding action and a heat radiating action, there has been known, for example, a combined heat radiating material and shield material for electronic parts disclosed in Japanese Patent Laid-open No. Hei 10-313191. The combined heat radiating material and shielding material for electronic parts includes a carbon material provided with a multiplicity of minute pores communicating from one side to the other side, and a metallic foil layer adhered to the carbon material with a hot-melt type adhesive. The combined heat radiating material and shield material for electronic parts is fitted to an electronic part, with the metallic foil layer on the side of the electronic part.

As the carbon material, for example, a plate-like member of carbon fibers is used. The carbon material functions as both an electromagnetic wave shield layer and a heat-radiating layer. In addition, the minute pores of the carbon material promotes radiation of heat. The publication describes that, on the other hand, as the metallic foil layer, aluminum and copper may be preferably used in view of thermal conductivity.

Besides, Japanese Patent Laid-open No. 2000-133985 discloses a shield cover for electronic parts which has an electromagnetic wave shielding effect and a heat-radiating effect. The shield cover for electronic parts includes an electrically conductive casing, and an electromagnetic wave absorbing layer formed of an electromagnetic wave loss material provided on a surface of the casing.

Further, the casing is provided with at least one communication hole, and the diameter of the communication hole is, for example, set to be not more than ¼ of the wavelength of the electromagnetic wave to be shielded. The heat generated from the electronic parts contained in the shield cover for electronic parts is radiated through the communication hole to the exterior of the casing.

Japanese Patent Laid-open No. 2000-101004 discloses a heat-radiating sheet having a high thermal conductivity and electromagnetic wave shielding characteristics. The heat-radiating sheet is produced by impregnating or charging or laminating a heat-conductive adhesive in or on one side or both sides of a metallic fiber sheet prepared by wet-type sheet formation and sintering of a slurry containing metallic fibers.

As the metallic fibers, there may be used, for example, stainless steel fibers, titanium fibers, nickel fibers, brass fibers, copper fibers, aluminum fibers or the like. Th e heat-conductive adhesive is prepared by mixing a heat-conductive filler with a matrix resin; as the heat-conductive filler, there are mentioned, for example, metals such as aluminum, gold, silver, copper and the like, metal oxides such as alumina, silica and the like, or boron nitride, aluminum nitride and the like.

The Japanese Patent Laid-open No. 2000-101004 describes that, in the case of impregnating the metallic fiber sheet with the heat-conductive adhesive or charging the heat-conductive adhesive into the metallic fiber sheet, the efficiency of heat conduction of the heat-radiating sheet can be more enhanced, as compared with the case of laminating the heat-conductive adhesive on one side or both sides of the metallic fiber sheet.

However, according to the combined heat-radiating material and shield material for electronic parts described in the above-mentioned Japanese Patent Laid-open No. Hei 10-313191, a metallic foil layer composed of aluminum or copper, for example, is used as the electromagnetic wave shield layer, and, specifically, use of a magnetic loss material suitable for shielding of high-frequency noises is not described in the publication.

In addition, according to the shield cover for electronic parts described in the Japanese Patent Laid-open No. 2000-133985, heat radiation is conducted through the communication hole provided in the casing. Therefore, shielding of electromagnetic waves is not achieved at the communication hole portion. Particularly in the case of a small-type electronic apparatus, the ratio of the area of the communication hole to the surface area of the casing is increased, so that the original function of the casing for protecting the electronic parts cannot be achieved.

Further, in order to form an electromagnetic wave absorbing layer uniformly and easily in the periphery of the communication hole, it is desirable that the electromagnetic wave absorbing layer is a coating. For example, in the case of forming the electromagnetic wave absorbing layer by a method other than coating, for example, by adhesion, it is necessary to form the electromagnetic wave absorbing layer so as not to close the communication hole, or to form the electromagnetic wave absorbing layer and then form an opening portion in the electromagnetic wave absorbing layer at the communication hole portion.

On the other hand, according to the heat-radiating sheet described in the Japanese Patent Laid-open No. 2000-101004, a metallic fiber sheet prepared by processing metallic fibers is used. Therefore, it is necessary to use a metal capable of being processed into thin wires. As such a metal, the Japanese Patent Laid-open No. 2000-101004 mentions stainless steel, titanium, nickel and the like, and the publication describes that stainless steel is particularly preferable in view of heat resistance and rust resistance.

Generally, processing of ferrite into thin wires is difficult, so that it is difficult to use a magnetic loss material such as ferrite in the heat-radiating sheet described in the Japanese Patent Laid-open No.2000-101004.

In addition to the above-mentioned various members for electronic parts, sheet-form noise countermeasure parts including a soft magnetic material powder dispersed in a polymer have also been developed. These are based on effective absorption and suppression of noise through utilization of magnetic loss of a magnetic material. The thermal conductivity of such noise countermeasure parts is not sufficiently high, and the noise countermeasure parts are generally low in heat radiation characteristics.

For the purpose of improving the heat radiation characteristics, an electromagnetic wave-absorbing heat-radiating sheet prepared by mixing heat-conductive particles with a soft magnetic material powder has also been developed.

Thus, although various members for electronic parts having both an electromagnetic wave shielding function and a heat-radiating function have been developed, a product capable of particularly reducing high-frequency noises and having a high heat radiation efficiency has not yet been obtained.

### SUMMARY OF THE INVENTION

An object of the present invention is to provide a sheet for electronic parts which has excellent performance in both shield of electromagnetic waves and radiation of heat, and a method of producing the same.

In order to attain the above object, a sheet for electronic parts according to the present invention is characterized by including an electromagnetic wave-absorbing heat-radiating layer containing a magnetic material powder, a heat-conductive powder and a resin, and an electrically conductive shield layer laminated on the electromagnetic wave-absorbing heat-radiating layer.

The sheet for electronic parts according to the present invention is preferably characterized by further including an adhesive layer between the electromagnetic wave-absorbing heat-radiating layer and the shield layer.

The sheet for electronic parts according to the present invention is preferably characterized in that the magnetic material powder contains a soft magnetic material powder. The sheet for electronic parts according to the present invention is more preferably characterized in that the magnetic material powder contains a ferrite. Alternatively, the sheet for electronic parts according to the present invention is more preferably characterized in that the magnetic material powder contains Sendust.

The sheet for electronic parts according to the present invention is preferably characterized in that the heat-conductive powder contains alumina. Alternatively, the sheet for electronic parts according to the present invention is preferably characterized in that the heat-conductive powder contains aluminum nitride.

The sheet for electronic parts according to the present invention is preferably characterized in that the shield layer includes a metallic foil. The sheet for electronic parts according to the present invention is more preferably characterized in that the metallic foil includes copper foil. Furthermore, the sheet for electronic parts according to the present invention is preferably characterized in that the metallic foil includes aluminum foil.

Alternatively, the sheet for electronic parts according to the present invention is preferably characterized in that the shield layer contains carbon powder and a resin.

By this, for example, unrequired radiation from the inside to the outside of electronic parts can be effectively reduced. The sheet for electronic parts according to the present invention can, for example, be adhered to the outer side of a casing incorporating an electronic circuit, or be directly adhered to an insulating substrate on which a semiconductor chip is mounted.

In addition, according to the sheet for electronic parts according to the present invention, the electromagnetic wave-absorbing heat-radiating layer and the shield layer have appropriate flexibility, so that the sheet for electronic parts can easily be adhered to a curved surface or bent in conformity with the shape of an adhesion portion.

In order to attain the above object, the sheet for electronic parts according to the present invention is characterized by further including a first electromagnetic wave-absorbing heat-radiating layer containing a magnetic material powder, a heat-conductive powder and a resin, an electrically conductive shield layer laminated on the electromagnetic wave-absorbing heat-radiating layer, and a second electromagnetic wave-absorbing heat-radiating layer containing a magnetic material powder, a heat-conductive powder and a resin laminated on the shield layer.

The sheet for electronic parts according to the present invention is preferably characterized by further including a first adhesive layer between the first electromagnetic wave-absorbing heat-radiating layer and the shield layer. The sheet for electronic parts according to the present invention is preferably characterized by further including a second adhesive layer between the second electromagnetic wave-absorbing heat-radiating layer and the shield layer.

The sheet for electronic parts according to the present invention is preferably characterized in that the magnetic material powder contains a soft magnetic material powder. The sheet for electronic parts according to the present invention is further preferably characterized in that the magnetic material powder contains a ferrite. Furthermore, the sheet for electronic parts according to the present invention is further preferably characterized in that the magnetic material powder contains Sendust.

The sheet for electronic parts according to the present invention is preferably characterized in that the heat-conductive powder contains alumina. Alternatively, the sheet for electronic parts according to the present invention is preferably characterized in that the heat-conductive powder contains aluminum nitride.

The sheet for electronic parts according to the present invention is preferably characterized in that the shield layer includes a metallic foil. The sheet for electronic parts according to the present invention is preferably characterized in that the metallic foil includes copper foil. Alternatively, the sheet for electronic parts according to the present invention is preferably characterized in that the metallic foil includes aluminum foil.

Alternatively, the sheet for electronic parts according to the present invention is preferably characterized in that the shield layer contains carbon powder and a resin.

By this, it is possible to effectively reduce both the unrequired radiation from the inside to the outside of electronic parts and the noises penetrating from the outside to the inside of electronic parts to exert influences on the operation of the electronic parts. Therefore, the sheet for electronic parts according to the present invention can be adhered to a portion where electromagnetic waves are incident from both sides, for example, the inside or outside of a casing incorporating an electronic circuit.

In addition, according to the sheet for electronic parts according to the present invention, the first and second electromagnetic wave-absorbing heat-radiating layers and the shield layer have appropriate flexibility, so that the sheet for electronic parts can easily be adhered to a curved surface or bent in conformity with the shape of an adhesion portion.

In order to attain the above object, a method of producing a sheet for electronic parts according to the present invention is characterized by including the steps of kneading at least a magnetic material powder and a heat-conductive powder with a resin to prepare a first kneaded material, extending the first kneaded material into a sheet form and curing the extended first kneaded material to form an electromagnetic wave-absorbing heat-radiating layer, forming an electrically conductive shield layer, and laminating the electromagnetic wave-absorbing heat-radiating layer and the shield layer.

The method of producing a sheet for electronic parts according to the present invention is preferably characterized in that the step of laminating the electromagnetic wave-absorbing heat-radiating layer and the shield layer includes the step of adhering the electromagnetic wave-absorbing heat-radiating layer and the shield layer by use of an adhesive.

The method of producing a sheet for electronic parts according to the present invention is preferably characterized in that the step of forming the shield layer includes the step of forming a metallic foil.

The method of producing a sheet for electronic parts according to the present invention is preferably characterized in that the step of forming the shield layer includes the steps of kneading at least an electrically conductive powder and a resin to prepare a second kneaded material, and extending the second kneaded material and curing the extended second kneaded material.

The method of producing a sheet for electronic parts according to the present invention is preferably characterized by further including the step of forming a second electromagnetic wave-absorbing heat-radiating layer containing at least a magnetic material powder, a heat-conductive powder and a resin on the side of the shield layer on which the electromagnetic wave-absorbing heat-radiating layer is not provided.

By this, a sheet for electronic parts capable of effectively reducing unrequired radiation, for example, from the inside to the outside of electronic parts can be produced through simple steps.

In order to attain the above object, the method of producing a sheet for electronic parts according to the present invention is characterized by including the steps of kneading at least a magnetic material powder and a heat-conductive powder with a resin to prepare a first kneaded material, kneading at least an electrically conductive powder with a resin to prepare a second kneaded material, laminating while extending the first and second kneaded materials into sheet forms, and curing the extended and laminated first and second kneaded materials.

The method of producing a sheet for electronic parts according to the present invention is preferably characterized by further including the step of forming a second electromagnetic wave-absorbing heat-radiating layer containing at least a magnetic material powder, a heat-conductive powder and a resin on the side of the shield layer on which the electromagnetic wave-absorbing heat-radiating layer is not provided.

By this, a sheet for electronic parts capable of effectively reducing both the unrequired radiation from the inside to the outside of electronic parts and the noise penetrating from the outside to the inside of electronic parts to exert influence on the operation of the electronic parts can be produced through simple steps.

### BRIEF DESCRIPTION OF THE DRAWINGS

FIG. 1 is a sectional view of an electromagnetic wave-absorbing heat-radiating shield sheet according to Embodiment 1 of the present invention;

FIG. 2 is a sectional view of an electromagnetic wave-absorbing heat-radiating shield sheet according to Embodiment 2 of the present invention; and

FIG. 3 is a sectional view of a semiconductor device to which the electromagnetic wave-absorbing heat-radiating shield sheet shown in FIG. 2 is applied, according to Embodiment 3 of the present invention.

### DETAILED DESCRIPTION OF THE PREFERRED EMBODIMENTS

Hereinafter, embodiments of a sheet for electronic parts and a method of producing the same according to the present invention will be described below referring to the drawings.

(Embodiment 1)

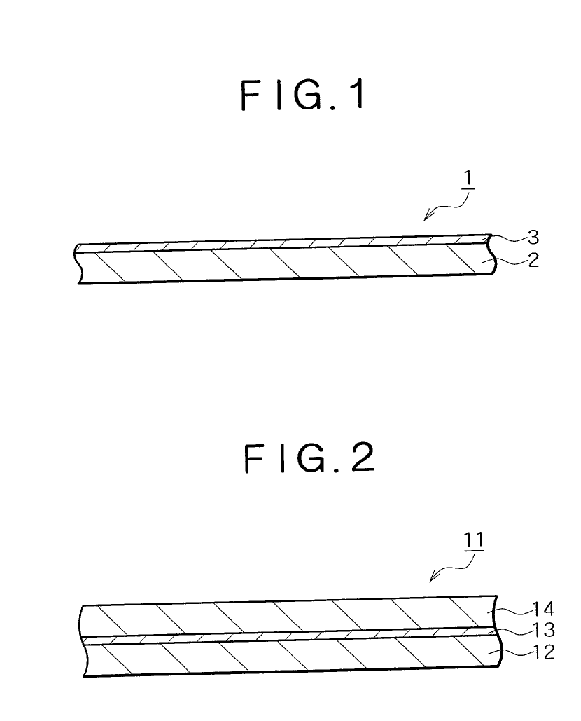

FIG. 1 is a sectional view of a sheet for electronic parts according to the present invention. The sheet for electronic parts 1 includes an electromagnetic wave-absorbing heat-radiating layer 2 and a shield layer 3. Ordinarily, the sheet for electronic parts 1 is disposed relative to the electronic part so that the electromagnetic wave-absorbing heat-radiating layer 2 is located on the side near to a source of unrequired radiation and the shield layer 3 is located on the side far away from the source of the unrequired radiation.

The electromagnetic wave-absorbing heat-radiating layer 2 is produced by kneading a soft magnetic material powder and a heat-conductive powder with a resin. The shield layer 3 is a layer including a metallic foil or an electrically conductive powder. The electromagnetic wave-absorbing heat-radiating layer 2 and the shield layer 3 are formed separately in sheet forms, which are then adhered to each other by use of an adhesive. Alternatively, the materials for the layers may be laminated while being extended and, thereafter, the laminated layers are cured in the integrated condition.

The electromagnetic wave-absorbing heat-radiating layer 2 contains, for example, a ferrite, Sendust or the like as the soft magnetic material powder. In addition, the electromagnetic wave-absorbing heat-radiating layer 2 contains, for example, alumina or aluminum nitride as the heat-conductive powder.

The shield layer 3 includes an electrically conductive material for reflecting electromagnetic waves. For example, a metallic foil consisting of copper, aluminum or the like may be used as the shield layer 3. Alternatively, a member prepared by kneading a powder of carbon or the like with a resin and processing the kneaded material into a sheet form may be used as the shield layer 3.

According to the sheet for electronic parts according to the present embodiment, unrequired radiation emitted from the inside to the outside of electronic parts can be effectively reduced. The sheet for electronic parts according to the present embodiment is preferably used, for example, in the case where the sheet for electronic parts is adhered to an outer side of a plastic-made casing incorporating an electronic circuit, or in the case where the sheet for electronic parts is adhered directly to an insulating substrate or the like on which a semiconductor chip is mounted.

In addition, according to the sheet for electronic parts according to the present embodiment, the electromagnetic wave-absorbing heat-radiating layer 2 is a layer containing a resin, and the shield layer 3 is a layer including a thin metallic foil or a resin, so that the sheet for electronic parts has appropriate flexibility. Therefore, the sheet for electronic parts can easily be adhered to a curved surface or bent in conformity with the shape of an adhesion portion.

(Embodiment 2)

FIG. 2 is a sectional view of a sheet for electronic parts according to the present embodiment. The sheet for electronic parts 11 has a structure in which an electromagnetic wave-absorbing heat-radiating layer 12, a shield layer 13 and an electromagnetic wave-absorbing heat-radiating layer 14 are laminated in order. The sheet for electronic parts 11 is disposed relative to an electronic part so that one of the electromagnetic wave-absorbing heat-radiating layer 12 and the electromagnetic wave-absorbing heat-radiating layer 14 is located on the side near to a source of unrequired radiation, and the other is located on the side far away from the source of the unrequired radiation.

The electromagnetic wave-absorbing heat-radiating layers 12 and 14 are produced by kneading a soft magnetic material powder and a heat-conductive powder with a resin. The compositions of the electromagnetic wave-absorbing heat-radiating layers 12 and 14 may be the same with each other or different from each other.

The shield layer 13 is a layer including a metallic foil or an electrically conductive powder. The electromagnetic wave-absorbing heat-radiating layer 12 and the shield layer 13 are formed separately in sheet forms and then adhered to each other by use of an adhesive. Similarly, the shield layer 13 and the electromagnetic wave-absorbing heat-radiating layer 14 are formed separately in sheet forms and then adhered to each other by use of an adhesive. Alternatively, the materials for the sheets may be laminated while being extended and, thereafter, the extended and laminated materials may be cured in the integrated condition.

The electromagnetic wave-absorbing heat-radiating layers 12 and 14 contain, for example, a ferrite, Sendust or the like as the soft magnetic material powder. In addition, the electromagnetic wave-absorbing heat-radiating layers 12 and 14 contain, for example, alumina or aluminum nitride as the heat-conductive powder.

The shield layer 13 includes an electrically conductive material for reflecting electromagnetic waves. For example, a metallic foil consisting of copper, aluminum or the like may be used as the shield layer 13. Alternatively, a member prepared by kneading a powder of carbon or the like with a resin and processing the kneaded material into a sheet form may be used as the shield layer 13.

According to the sheet for electronic parts according to the present embodiment, both the unrequired radiation emitted from the inside to the outside of an electronic part and the noise penetrating from the outside to the inside of the electronic part to exert influence on the operation of the electronic part can be effectively reduced. Therefore, the sheet for electronic parts according to the present embodiment can be preferably used, for example, in the case where the sheet for electronic parts is adhered to a portion on which electromagnetic waves are incident from both sides, such as the inner side or outer side of a casing incorporating an electronic circuit.

In addition, according to the sheet for electronic parts according to the present embodiment, the electromagnetic wave-absorbing heat-radiating layers 12 and 14 are layers containing a resin, and the shield layer 13 is a layer including a thin metallic foil or a resin, so that the sheet for electronic parts has appropriate flexibility. Therefore, the sheet for electronic parts can easily be adhered to a curved surface or bent in conformity with the shape of an adhesion portion.

(Embodiment 3)

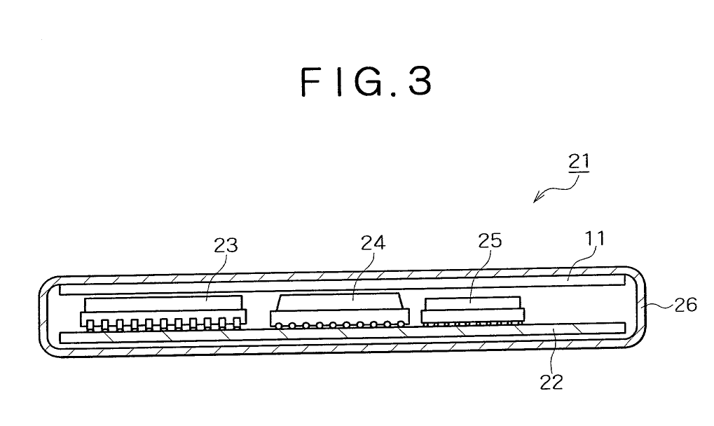

FIG. 3 is a sectional view of a semiconductor device including the sheet for electronic parts (See FIG. 2) shown in Embodiment 2. In the semiconductor device 21 shown in FIG. 3, a plurality of semiconductor chips 23, 24 and 25 are mounted on an insulating substrate 22. The semiconductor chips 23, 24 and 25 include, for example, high-frequency circuits on the GHz level. The insulating substrate 22 and the semiconductor chips 23, 24 and 25 are contained in a plastic-made casing 26.

The sheet for electronic parts 11 is adhered to the inside wall of the casing 26, for example, by use of an adhesive. The sheet for electronic parts 11 has a structure in which an electromagnetic wave-absorbing heat-radiating layer 12, a shield layer 13 and an electromagnetic wave-absorbing heat-radiating layer 14 are laminated in order. Here, for convenience, the side in close contact with the inside wall of the casing 26 is made to be the electromagnetic wave-absorbing heat-radiating layer 12, and the side near to the semiconductor chips 23, 24, and 25 is made to be the electromagnetic wave-absorbing heat-radiating layer 14.

The electromagnetic wave-absorbing heat-radiating layers 12 and 14 contain a soft magnetic material powder and a heat-conductive powder, so that these layers absorb incident electromagnetic waves and promote the radiation of heat from electronic parts. The shield layer 13 is an electrically conductive layer consisting of a metal or carbon, and reflects the electromagnetic waves incident on the shield layer 13.

According to the semiconductor device 21 having the above constitution, the noise penetrating from the outside of the casing 26 into the inside of the casing 26 is first absorbed by the electromagnetic wave-absorbing heat-radiating layer 12. The noise penetrating through the electromagnetic wave-absorbing heat-radiating layer 12 is partly reflected by the shield layer 13. The noise attenuated while penetrating through the electromagnetic wave-absorbing heat-radiating layer 12 and the shield layer 13 is absorbed by the electromagnetic wave-absorbing heat-radiating layer 14, whereby the noise is further attenuated. By this, the noise penetrating from the outside of the casing 26 to exert influence on the operations of the semiconductor chips 23, 24, and 25 is effectively reduced.

In addition, since the electromagnetic wave-absorbing heat-radiating layers 12 and 14 contain a heat-conductive powder, heat is efficiently radiated from the semiconductor chips 23, 24, and 25. The heat generated in the semiconductor chips 23, 24, and 25 is diffused through conduction of heat from the electromagnetic wave-absorbing heat-radiating layer 12 to the casing 26.

Embodiments of the sheet for electronic parts according to the present invention are not limited to the above description. For example, in Embodiment 3 above, the sheet for electronic parts 11 is provided on the whole surface on the inside of one surface of the casing 26; however, the sheet for electronic parts 11 can be imitatively provided at a portion where unrequired radiation matters particularly.

Besides, various modifications can be made without departure from the gist of the present invention.

According to the sheet for electronic parts according to the present invention, noise of unrequired radiation can be reduced, and radiation of heat from electronic parts can be achieved efficiently.

According to the method of producing a sheet for electronic parts according to the present invention, a sheet for electronic parts having high performance in both shielding of electromagnetic waves and radiation of heat can be produced through simple steps.

While a preferred embodiment of the present invention has been described using specific terms, such description is for illustrative purposes only, and it is to be understood that changes and variations may be made without departing from the spirit or scope of the following claims.

What is claimed is:

1. A sheet for electronic parts comprising:
an electromagnetic wave-absorbing heat-radiating layer containing a magnetic material powder, a heat-conductive powder and a resin, and
an electrically conductive shield layer laminated on said electromagnetic wave-absorbing heat-radiating layer.

2. A sheet for electronic parts as claimed in claim 1, further comprises an adhesive layer between said electromagnetic wave-absorbing heat-radiating layer and said shield layer.

3. A sheet for electronic parts as claimed in claim 1, wherein said magnetic material powder contains a soft magnetic material powder.

4. A sheet for electronic parts as claimed in claim 3, wherein said magnetic material powder contains a ferrite.

5. A sheet for electronic parts as claimed in claim 3, wherein said magnetic material powder contains Sendust.

6. A sheet for electronic parts as claimed in claim 1, wherein said heat-conductive powder contains alumina.

7. A sheet for electronic parts as claimed in claim 1, wherein said heat-conductive powder contains aluminum nitride.

8. A sheet for electronic parts as claimed in claim 1, wherein said shield layer comprises a metallic foil.

9. A sheet for electronic parts as claimed in claim 8, wherein said metallic foil comprises copper foil.

10. A sheet for electronic parts as claimed in claim 8, wherein said metallic foil comprises aluminum foil.

11. A sheet for electronic parts as claimed in claim 1, wherein said shield layer contains carbon powder and a resin.

12. A sheet for electronic parts comprising:
a first electromagnetic wave-absorbing heat-radiating layer containing a magnetic material powder, a heat-conductive powder and a resin,
an electrically conductive shield layer laminated on said electromagnetic wave-absorbing heat-conductive layer, and further
a second electromagnetic wave-absorbing heat-radiating layer containing a magnetic material powder, a heat-conductive powder and a resin, laminated on said shield layer.

13. A sheet for electronic parts as claimed in claim 12, further comprises a first adhesive layer between said first electromagnetic wave-absorbing heat-radiating layer and said shield layer.

14. A sheet for electronic parts as claimed in claim 12, further comprises a second adhesive layer between said second electromagnetic wave-absorbing heat-radiating layer and said shield layer.

15. A sheet for electronic parts as claimed in claim 12, wherein said magnetic material powder contains a soft magnetic material powder.

16. A sheet for electronic parts as claimed in claim 15, wherein said magnetic material powder contains a ferrite.

17. A sheet for electronic parts as claimed in claim 15, wherein said magnetic material powder contains Sendust.

18. A sheet for electronic parts as claimed in claim 12, wherein said heat-conductive powder contains alumina.

19. A sheet for electronic parts as claimed in claim 12, wherein said heat-conductive powder contains aluminum nitride.

20. A sheet for electronic parts as claimed in claim 12, wherein said shield layer comprises a metallic foil.

21. A sheet for electronic parts as claimed in claim 20, wherein said metallic foil comprises copper foil.

22. A sheet for electronic parts as claimed in claim 20, wherein said metallic foil comprises aluminum foil.

23. A sheet for electronic parts as claimed in claim 21, wherein said shield layer contains carbon powder and a resin.

24. A method of producing a sheet for electronic parts comprising the steps of:
kneading at least a magnetic material powder and a heat-conductive powder with a resin to prepare a first kneaded material,
extending said first kneaded material into a sheet form and curing said sheet form first kneaded material to form an electromagnetic wave-absorbing heat-radiating layer,
forming an electrically conductive shield layer, and
laminating said electromagnetic wave-absorbing heat-radiating layer and said shield layer on each other.

25. A method of producing a sheet for electronic parts as claimed in claim 24, wherein
said step of laminating said electromagnetic wave-absorbing heat-radiating layer and said shield layer on each other comprises the step of adhering said electromagnetic wave-absorbing heat-radiating layer and said shield layer to each other by use of an adhesive.

26. A method of producing a sheet for electronic parts as claimed in claim 25, wherein said step of forming said shield layer comprises the step of forming a metallic foil.

27. A method of producing a sheet for electronic parts as claimed in claim 25, wherein
said step of forming said shield layer comprises the steps of kneading at least an electrically conductive powder and a resin to prepare a second kneaded material, and
extending said second kneaded material and curing said extended second kneaded material.

28. A method of producing a sheet for electronic parts as claimed in claim 24, further comprising the step of:
forming a second electromagnetic wave-absorbing heat-radiating layer containing at least a magnetic material powder, a heat-conductive powder and a resin, on the side of said shield layer on which said electromagnetic wave-absorbing heat-radiating layer is not provided.

29. A method of producing a sheet for electronic parts comprising the steps of:
kneading at least a magnetic material powder and a heat-conductive powder with a resin to prepare a first kneaded material,
kneading at least an electrically conductive powder and a resin to prepare a second kneaded material,
laminating said first and second kneaded materials while extending said first and second kneaded materials into sheet forms, and
curing said extended and laminated first and second kneaded materials.

30. A method of producing a sheet for electronic parts as claimed in claim 29, further comprising the step of:
forming a second electromagnetic wave-absorbing heat-radiating layer containing at least a magnetic material powder, a heat-conductive powder and a resin, on the side of said shield layer on which said electromagnetic wave-absorbing heat-radiating layer is not provided.
